(19) United States
(12) Patent Application Publication
(10) Pub. No.: US 2026/0167061 A1
(43) Pub. Date: Jun. 18, 2026

(54) APPARATUS AND METHOD FOR CONTROLLING A SEAT OF A VEHICLE

(71) Applicants: HYUNDAI MOTOR COMPANY, Seoul (KR); KIA CORPORATION, Seoul (KR)

(72) Inventors: Dong Hoon Lee, Hwaseong-si (KR); Yo Han Kim, Hwaseong-si (KR); Ji Su Kim, Hwaseong-si (KR); Seong Min Kim, Hwaseong-si (KR); Kug Hun Han, Hwaseong-si (KR); Mun Seung Kang, Hwaseong-si (KR)

(73) Assignees: HYUNDAI MOTOR COMPANY, Seoul (KR); KIA CORPORATION, Seoul (KR)

(21) Appl. No.: 19/230,968

(22) Filed: Jun. 6, 2025

(30) Foreign Application Priority Data
Dec. 13, 2024 (KR) 10-2024-0186137

(51) Int. Cl. B60N 2/02

(52) U.S. Cl. CPC B60N 2/0278; B60N 2/0277

(57) ABSTRACT

A vehicle seat is controlled by an apparatus and method. The apparatus includes a processor to control a movement position of a first-row seat according to whether a passenger is seated thereon and to then perform relaxation control of a second-row seat, positioned behind the first-row seat, in response to a relaxation control command input for the second-row seat. The apparatus includes a storage to store data and algorithms driven by the processor. A sliding moving section of the first-row seat includes a seating section capable of being sat on and a non-seating section not capable of being sat on. The processor is configured to control movement of the first-row seat to a reference position, which is a frontmost position in the seating section, and an extended position, which is a frontmost position in the non-seating section, according to whether a passenger is seated on the first-row seat.

### CROSS-REFERENCE TO RELATED APPLICATION

This application claims priority to and the benefit of Korean Patent Application No. 10-2024-0186137, filed with the Korean Intellectual Property Office on Dec. 13, 2024, the entire contents of which are incorporated herein by reference.

### BACKGROUND

### (a) Field

The present disclosure relates to a vehicle seat control apparatus and a method therefor, and more specifically, to a technique for controlling a seat position of a passenger vehicle to maximize a boarding space.

### (b) Description of the Related Art

In general, a vehicle's power seat is designed to maintain a passenger's seating position and posture. The power seat is configured to include a seat cushion and a seat back on a seat frame that moves on a seat rail. Furthermore, a rear of the seat rail and seat frame are equipped with a sliding device and a reclining device to maintain a driving posture suitable for a passenger's body type.

Such a power seat device converts electrical energy into physical movement energy by a passenger's hand manipulating a lever or switch. The sliding and reclining devices then operate to move a seat forward and backward or adjust an angle of the seatback tilt.

However, conventional power seats have a limited range of slide movements that passengers can control through manual switches, rather than the range physically provided by law.

In particular, in passenger vehicles with three or more rows, in a case where a passenger seated on a second-row seat attempts to control auto-relaxation, a first-row seat needs to be moved forward slightly, further than a legally restricted position, to secure leg room for the passenger seated on the second-row seat.

### SUMMARY

Embodiments of the present disclosure provide a vehicle seat control apparatus and a method therefor, capable of smoothly securing a space for passengers seated on second-row seats by controlling a position of a first-row seat in a vehicle having multiple rows of seats to be moved further than a position restricted by regulations.

Furthermore, embodiments of the present disclosure provide a vehicle seat control apparatus and a method therefor, capable of increasing passenger convenience by controlling a position of a first-row seat based on body information of a passenger seated on a second-row seat in a vehicle having multiple rows of seats.

The technical objects of the present disclosure are not limited to the objects mentioned above. Other technical objects not mentioned herein may be more clearly understood by those having ordinary skill in the art from the drawings, written description, and claims.

An embodiment of the present disclosure provides a vehicle seat control apparatus for a vehicle including a first-row seat and a second row seat. The apparatus includes a processor configured to control a movement position of a first-row seat according to whether a passenger is seated on the first-row seat and then to perform relaxation control of a second-row seat, in response to a relaxation control command being input for the second-row seat. The apparatus also includes a storage configured to store data and algorithms driven by the processor. A sliding moving section, i.e., a range of travel, of the first-row seat includes a seating section that is pre-determined as a section of the first-row seat range of travel that is able to be seated on and a non-seating section of the range of travel that is pre-determined as a section of the first-row seat range of travel that is unable to be seated on. The processor is configured to selectively control movement of the first-row seat to a reference position, which is a frontmost position in the seating section, and an extended position, which is a frontmost position in the non-seating section, according to whether a passenger is seated on the first-row seat.

In an embodiment of the present disclosure, the processor may be configured to control the first-row seat to move to the reference position in response to a case where a passenger is seated on the first-row seat.

In an embodiment of the present disclosure, the processor may be configured to control the first-row seat to move to the extended position in response to a case where no passenger is seated on the first-row seat.

In an embodiment of the present disclosure, the non-seating section may include a section extended from the seating section.

In an embodiment of the present disclosure, the processor may be configured, in response to a case where the passenger is detected to be seated on the first-row seat, to determine whether the first-row seat is positioned at the reference position.

In an embodiment of the present disclosure, the processor may be configured to control the first-row seat to move to the reference position in response to a case where the first-row seat positioned in the non-seating section.

In an embodiment of the present disclosure, the processor may be configured to detect whether the passenger is seated on the first-row seat based on whether a door is open, whether a seat belt is fastened, a detection result of a load sensor, a detection result of a mat sensor, an input of a seat control switch from the non-seating section to the seating section, and/or the like.

In an embodiment of the present disclosure, the processor may be configured, in response to a case where no passenger is seated on the first-row seat, to determine body information of the passenger seated on the second-row seat and to control a position of the first-row seat using the body information of the passenger seated on the second-row seat.

In an embodiment of the present disclosure, the processor may be configured to determine whether the passenger seated on the second-row seat is an infant or under a predetermined age, and to control the first row seat to move to the reference position in response to a case where the passenger seated on the second row seat is an infant or under the predetermined age.

In an embodiment of the present disclosure, the processor may be configured, in response to a case where the passenger seated on the second row seat is not an infant or is over the predetermined age, to determine a leg length of the passenger seated on the second-row seat.

In an embodiment of the present disclosure, the processor may be configured to determine whether the leg length of the passenger seated on the second-row seat is equal to or less than a reference value and, in response to a case where the leg length of the passenger seated on the second-row seat is equal to or less than the reference value, to control a position of the first-row seat according to the leg length of the passenger seated on the second row seat.

In an embodiment of the present disclosure, the processor may be configured to move the position of the first row seat to a position closer to the reference position among available positions of the seating section when the leg length of the occupant seated on the second row seat is less than or equal to the reference value and when the leg length of the occupant seated on the second row seat is longer, i.e., closer in length to the reference value.

In an embodiment of the present disclosure, the processor may be configured, in response to a case where the leg length of the passenger seated on the second-row seat is greater than the reference value, to control the first row seat to move to the extended position.

In an embodiment of the present disclosure, the processor may be configured, in response to a case where a passenger is seated on the first-row seat, to determine body information of the passenger seated on the first-row seat and body information of a passenger seated on the second row seat, and to control a position of the first row seat by using, i.e., based on the body information of the passenger seated on the first-row seat and the body information of the passenger seated in the second-row seat.

In an embodiment of the present disclosure, the processor may be configured, in response to a case where no passenger is seated on the first-row seat, to control reclining of the second-row seat to a frontmost position along with movement control of the first-row seat, control tilt of the second-row seat to a lowest position, and control a backrest height of the second-row seat to a lowest position.

An embodiment of the present disclosure provides a vehicle seat control method. The method includes inputting a relaxation control command for a second-row seat in a vehicle that has a first row seat and the second-row seat behind or rearward of the first row seat. The method also includes controlling a moving position of the first-row seat according to whether a passenger is seated on the first-row seat and performing relaxation control of the second-row seat. A sliding moving section, i.e., a range of travel, of the first-row seat includes a seating section that is pre-determined as a section of the range of travel that is able to be seated on and a non-seating section that is pre-determined as a section of the range of travel that is unable to be seated on. Also, controlling the moving position of the first-row seat may include selectively controlling movement of the first-row seat to a reference position, which is a frontmost position in the seating section, and an extended position, which is a frontmost position in the non-seating section, according to whether a passenger is seated on the first-row seat.

In an embodiment of the present disclosure, controlling the moving position of the first-row seat may include controlling the first-row seat to move to the reference position in response to a case where the passenger is seated on the first-row seat.

In an embodiment of the present disclosure, controlling the moving position of the first-row seat may include controlling the first-row seat to move to the extended position in response to a case where no passenger is seated on the first-row seat.

In an embodiment of the present disclosure, the non-seating section may include a section extended from the seating section.

In an embodiment of the present disclosure, the controlling of the moving position of the first-row seat may further include, in response to a case where a passenger is detected to be seated on the first-row seat, determining whether the first-row sheet is positioned at the reference position and controlling the first-row seat to move to the reference position in a case where the first-row seat is positioned in the non-seating section.

Accordingly, it may be possible to smoothly secure a space for passengers seated on second-row seats by controlling a position of a first-row seat in a vehicle having multiple rows of seats to be moved further than a position restricted by regulations.

Furthermore, accordingly, it may be possible to increase passenger convenience by controlling a position of a first-row seat based on body information of a passenger seated on a second-row seat in a vehicle having multiple rows of seats.

Furthermore, various effects, which may be directly or indirectly identified through the present specification, may be provided.

### BRIEF DESCRIPTION OF THE DRAWINGS

FIG. 1 illustrates a block diagram showing an example configuration of a vehicle system including a vehicle seat control apparatus.

FIGS. 2A-2D illustrate views of an example moving section of a vehicle seat.

FIG. 3 illustrates a flowchart of an example control method of a second-row seat in a vehicle.

FIG. 4 illustrates a flowchart of an example control method of a first-row seat in a vehicle.

FIG. 5 illustrates a flowchart of another example control method of a second-row seat in a vehicle.

FIG. 6 illustrates a flowchart of a control method of a second-row seat according to body information of a passenger seated on the second-row seat of FIG. 5.

FIG. 7 illustrates a flowchart of a control method of a second-row seat based on body information of a passenger seated on a first-row seat and body information of a passenger seated on a second-row seat in FIG. 5.

FIG. 8 illustrates an example computing system.

### DETAILED DESCRIPTION

Hereinafter, some embodiments of the present disclosure are described in detail with reference to various drawings. It should be noted that, in adding reference numerals to constituent elements of each drawing, the same constituent elements include the same reference numerals even though the constituent elements are shown in different drawings. In describing embodiments of the present disclosure, where it has been determined that a detailed description of the well-known configuration or function associated with the embodiments may have obscured the gist of the present disclosure, the description has been omitted.

In describing constituent elements according to embodiments of the present disclosure, terms such as first, second, A, B, (a), and (b) may be used. These terms are only used for distinguishing the constituent elements from other constituent elements, and the nature, sequences, or orders of the constituent elements are not limited by the terms. Furthermore, all terms used herein including technical scientific terms have the same meanings as generally understood by those of ordinary skill in the technical field to which embodiments of the present disclosure pertain unless the terms are differently defined. Terms defined in a generally used dictionary shall be construed to have meanings consistent with those in the context of the related art, and should not be construed to have idealized or excessively formal meanings unless the terms are clearly defined in the present specification.

When a component, device, unit, module, controller, element, apparatus, or the like of the present disclosure is described as having a purpose or performing an operation, function, or the like, the component, device, unit, module, controller, apparatus, or element should be considered herein as being “configured to” meet that purpose or to perform that operation or function. The present disclosure describes an apparatus with devices for controlling a seat position of vehicle seats. The apparatus, devices, or other such components may separately embody or be included with a processor and a memory or storage, such as a non-transitory computer readable media, as part of the apparatus, devices, and the like.

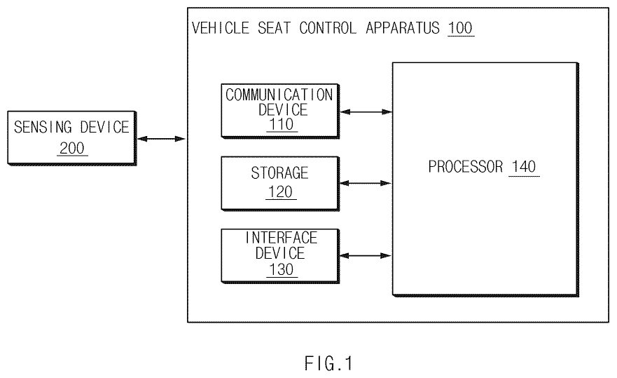

Hereinafter, various embodiments of the present disclosure are described in detail with reference to FIGS. 1-8.

FIG. 1 illustrates a block diagram showing an example configuration of a vehicle system including a vehicle seat control apparatus.

Referring to FIG. 1, the vehicle system according to an embodiment of the present disclosure may include a vehicle seat control apparatus 100 and a sensing device 200.

According to an embodiment of the present disclosure, the vehicle seat control apparatus 100 may be implemented within or separately from a vehicle. In this case, the vehicle seat control apparatus 100 may be integrally formed with internal control units of the vehicle, or may be implemented as a separate hardware device to be connected to control units of the vehicle. For example, the vehicle seat control apparatus 100 may be implemented integrally with the vehicle or may be implemented in a form that is installed or attached to the vehicle as a configuration separate from the vehicle. Alternatively, a part of the vehicle seat control apparatus 100 may be implemented integrally with the vehicle and another part may be implemented in a form that is installed or attached to the vehicle as a configuration separate from the vehicle.

A vehicle may include multiple rows (e.g., a first row, a second row, a third row) of seats, i.e., the vehicle may include a first-row seat and a second-row seat rearward of or behind the first-row seat. In such a vehicle, the vehicle seat control apparatus 100 may be configured to control a movement position of the first-row seat according to whether a passenger is seated on the first-row seat and to then perform relaxation control of the second-row seat, in response to a relaxation control command being input for the second-row seat.

In a vehicle with first-row and second-row seats, the vehicle seat control apparatus 100 may have to move the first-row seat further forward to secure leg room for a passenger seated on the second-row seat seeking to move the second-row seat for auto-relaxation. To this end, the vehicle seat control apparatus 100 may be configured to move the first-row seat forward a little further than a position restricted by law according to whether there is a passenger seated on the first-row seat.

In other words, in a case where there are no passengers seated on the first-row seats, the first-row seats may be moved to an extended position of a non-seating section (see below for the meaning of “section”) or position, and manual manipulation by passengers may be restricted in that section. On the other hand, in a case where there is a passenger seated on the first-row seat, the first-row seat may be moved to a reference position of the seating section.

In this case, the first-row seats and the second-row seats may be power seats, and may provide a long slide function, such as in fore and aft directions within the vehicle. The vehicle seat control apparatus 100 of the present disclosure may be applied to a vehicle in which a section (seating section) within an adjustable range of travel of the seat that a passenger can manually manipulate is legally defined.

The vehicle seat control apparatus 100 may include a communication device 110, a storage 120, an interface device 130, and a processor 140. According to an embodiment of the present disclosure, the vehicle seat control apparatus 100 may be implemented as a single body by coupling components with each other. Also, some components may be omitted.

The communication device 110 is a hardware device implemented with various electronic circuits to transmit and receive signals through a wireless or wired connection. The communication device 110 may transmit and receive information based on in-vehicle devices and in-vehicle network communication techniques. As an embodiment of the present disclosure, the in-vehicle network communication techniques may include Controller Area Network (CAN) communication, Local Interconnect Network (LIN) communication, flex-ray communication, and the like.

The communication device 110 is a hardware device implemented with various electronic circuits to transmit and receive signals through a wireless or wired connection. The communication device 110 may transmit and receive information with internal devices such as vehicles, ships, airplanes, urban air mobilities (UAM), and electric kickboards, equipped with displays, based on network communication techniques. As an embodiment of the present disclosure, the in-vehicle network communication techniques may include Controller Area Network (CAN) communication, Local Interconnect Network (LIN) communication, flex-ray communication, and/or the like.

The communication device 110 may perform V2X communication. The V2X communication may include: communication between vehicle and all entities such as vehicle-to-vehicle (V2V) communication, which refers to communication between vehicles; vehicle to infrastructure (V2I) communication, which refers to communication between a vehicle and an evolved node B (eNB) or road side unit (RSU); vehicle-to-pedestrian V2P) communication, which refers r to communication between user equipment (UE) held by vehicles and individuals (pedestrians, cyclists, vehicle drivers, or occupants); and/or vehicle-to-network V2N) communication.

Furthermore, the communication device 110 may include a mobile communication module, a wireless Internet module, a short-range communication module, etc, for communication with outside of the vehicle.

The mobile communication module may be configured to perform communication using technical standards or communication methods for mobile communication. Such mobile communication may include Global System for Mobile communication (GSM), Code Division Multi access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), etc.

The wireless Internet module refers to a module for wireless Internet access, and may be configured to perform communication through Wireless LAN (WLAN), Wireless-Fidelity (Wi-Fi), Wi-Fi direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), etc.

The short-range communication module may support short-range communication by using at least one of Bluetooth™, radio frequency identification (RFID), infrared data association (IrDA), ultra wideband (UWB), ZigBee, near field communication (NFC), a wireless universal serial bus (USB) technique, or any combination thereof.

The storage 120 may store sensing results of the sensing device 200 and data and/or algorithms required for the processor 140 to operate, and the like.

For example, the storage 120 may store profile information including identification information for identifying a passenger, physical information of the passenger, etc. The identification information may include facial features, etc., and the profile information may include a height of the passenger and seated height, etc. Furthermore, the storage 120 may store passenger body information sensed by the sensing device 200. Furthermore, the storage 120 may store algorithms and data for determining passenger's age and physical information.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and/or an optical disk.

The interface device 130 may include an input aspect for receiving a control command from a user and an output means for outputting an operation state of the apparatus 100 and results thereof. Herein, the input aspect may include a key button, and may include a mouse, a joystick, a jog shuttle, a stylus pen, and/or the like. Furthermore, the input aspect may include a soft key implemented on the display.

The interface device 130 may be implemented as a head-up display (HUD), an instrument cluster, an audio video navigation (AVN), a human machine interface (HM), and/or a human machine interface (HMI).

The output device may include a display, and may also include a voice output aspect such as a speaker. In the instant case, in response to a a touch sensor formed of a touch film, a touch sheet, or a touch pad that is provided on the display, the display may operate as a touch screen, and may be implemented in a form in which an input device and an output device are integrated. In the present disclosure, the output aspect may output status information such as sliding positions of seats in a vehicle.

In the instant case, the display may include at least one of a liquid crystal display (LCD), a thin film transistor liquid crystal display (TFT LCD), an organic light emitting diode display (OLED display), a flexible display, a field emission display (FED), and/or a 3D display.

The processor 140 may be electrically connected to the communication device 110, the storage 120, the interface unit 130, etc., and may be configured to perform overall control such that each component may normally perform its intended function. Furthermore, the processor 140 may be an electrical circuit that may be configured to electrically control each component and to execute a command of software, thereby performing various data processing and calculations, such as those described below.

The processor 140 may be implemented in the form of hardware, software, or a combination of and software. For example, the processor 140 may be implemented as a microprocessor, but the present disclosure is not limited thereto. For example, the processor may be, an electronic control unit (ECU), a micro controller unit (MCU), or other subcontrollers mounted in the vehicle.

The processor 140 may be implemented with an application specific integrated circuit (ASIC), a digital signal processor (DSP), a programmable logic device (PLD), a field programmable gate array (FPGA), a central processing unit (CPU), a microcontroller, a microprocessor and/or the like.

In a vehicle including a first-row seat and a second-row seat rearward of or behind the first-row seat, the processor 140 may be configured to control a movement position of the first-row seat according to whether a passenger is seated on the first-row seat and then to perform relaxation control of the second-row seat, in response to a a relaxation control command being input for the second-row seat. As described herein, a first-row seat or seats and a second-row seat or seats may be movable by sliding to change the position of one or more of the seats. The seats may be mounted to slide along one or more track, seat tracks, or the like. In one example, the seats may be slidable to travel in a fore-aft or lengthwise direction of the vehicle to change a seat position. The seats may be movable so as to travel through a range of possible or selectable positions, where the range of travel may be referred to as a section. The range of seat positions, i.e., the section, may be divided among a seating section, i.e., a first portion of the range of travel, and one or more non-seating sections, i.e., a second portion, third portion, etc. of the range of travel, at one or at each end of the seat range of travel. The seating section for a given seat includes seat positions within the range of travel or positions where a passenger is permitted to sit on the seat. The non-seating section or sections for a given seat include seat positions within the range of travel or positions, but outside or not within the seating section and where a passenger is not permitted to sit on the seat.

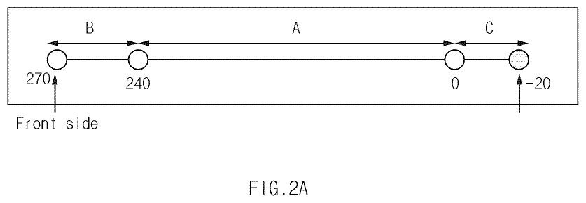

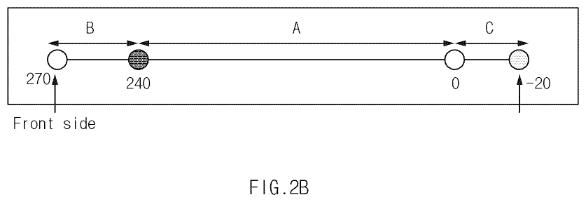

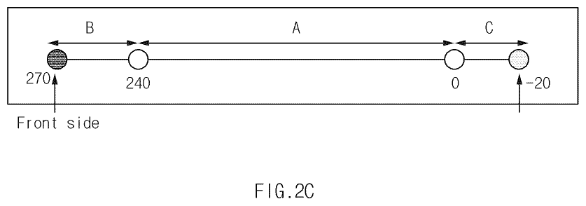

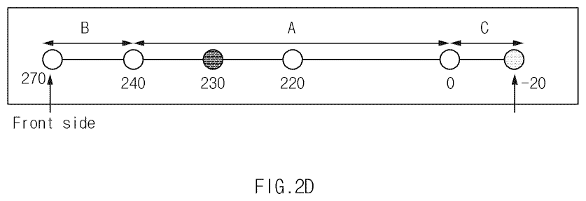

A section of the first-row seat may include a seating section A that is pre-determined as a section where the seat is at a position where a passenger is able to be seated on the first-row seat. The section may also include non-seating sections B and C that are pre-determined as sections where the seat is at a position where a passenger is unable to be seated on the first-row seat. See, for example, FIG. 2A. The non-seating section B may be a section extending from, i.e., beyond the seating section A. The first-row seat may be moved to the non-seating section B or within the seating section A according to whether a passenger is seated on the first-row seat or according to physical information of the passenger. That is to say, a reference position 240, which may be considered as a frontmost position of the seating section A, and an extended position 270, which is a frontmost position of the non-seating section B, may be distinguished from one another. The first-row seat may be moved to the reference position 240 or the extended position 270. In the instant case, the seating section A and the non-seating sections B and C may be determined by law, and a vehicle seat may be set to be moved within the seating section A. However, in the present disclosure, even in a non-seating section, the first-row seat may be controlled to move as far as possible in a first-row direction to the extended position 270 in the non-seating section B to secure additional space for the second-row seat. Though not described in detail herein, the non-seating section C may be utilized to move the front-row seat further rearward beyond the seating section A in a manner similar to that described herein with respect to non-seating section B, but in a rearward direction toward the second-row seats. Furthermore, sizes, i.e., distances, lengths, ranges of travel, etc. of the seating section A and non-seating sections B and C may be determined by law.

The processor 140 may be configured to control movement of the first-row seat to the reference position 240, which is the frontmost position in the seating section A, and to the extended position 270, which is the frontmost position in the non-seating section B, according to whether a passenger is boarding or seated on the first-row seat.

In other words, in a case where a passenger is seated on the first-row seat, the processor 140 may be configured to control movement of the first-row seat to the reference position 240 as shown in FIG. 2B. In a case where no passenger is seated on the first-row seat, the processor 140 may be configured to control movement of the first-row seat to the extended position 270 as shown in FIG. 2C.

In response to detecting that a passenger is boarding or seated on the first-row seat, the processor 140 may be configured to determine whether the first-row seat is positioned at the reference position 240.

The processor 140 may be configured to control movement of the first-row seat back to the reference position 240 in response to a case where the first-row seat resides or is positioned in the non-seating section B.

In a case where no passenger is seated on the first-row seat, the processor 140 may be configured to determine body information of a passenger seated on the second-row seat and to control a position of the first-row seat using the body information of the passenger seated on the second-row seat.

In other words, the processor 140 may be configured to determine whether the passenger seated on the second-row seat is an infant or under a predetermined age. In response to a case where the passenger seated on the second-row seat is an infant or under the predetermined age, the processor 140 may be configured to control the movement of the first-row seat to the reference position 240.

The processor 140 may be configured to determine a leg length of a passenger seated on the second-row seat in response to a case where the passenger seated on the second-row seat is not an infant or is older than the predetermined age. In one example, the processor 140 may be configured to determine the leg length by subtracting a sitting height from a standing height of the passenger. Information related to the standing height and the sitting height may be obtained from pre-stored profile information or by using a camera, one or more sensors, etc.

The processor 140 may be configured to determine whether the leg length of a passenger seated on the second-row seat is less than or equal to a reference value. In response to a case where the leg length of the passenger seated on the second-row seat is less than or equal to the reference value, the position of the first-row seat may be controlled according to the leg length of the passenger seated on the second-row seat.

The processor 140 may be configured to control a position of the first-row seat to be moved to a position closer to the reference position 240 among the seating sections as the leg length of the passenger seated on the second-row seat is less than or equal to the reference value and the leg length of the passenger seated on the second-row seat is longer. For example, in a case where the leg length of the passenger seated on the second-row seat is long, the first-row seat may be moved to a position 230, which is close to the reference position 240 in FIG. 2D.

The processor 140 may be configured to control the movement of the first-row seat to the extended position 270 in response to a case where the leg length of the passenger seated on the second row seat is greater than the reference value.

In response to a case where the passenger is seated on the first-row seat, the processor 140 may be configured to determine body information of the passenger seated on the first-row seat and body information of the passenger seated on the second-row seat. The processor 140 may also be configured to control a position of the first-row seat using the body information of the passenger seated on the first-row seat and the body information of the passenger seated on the second-row seat.

In response to a case where there is no passenger in the first row seat, the processor 140 may be configured to control the movement of the first-row seat, control reclining of the second-row seat to the frontmost position, control a tilt of the second-row seat to a lowest position, and control a height of a backrest of the second-row seat to the lowest position.

The sensing device 200 may be configured to determine whether a passenger is in the vehicle and to detect body information of the passenger in the vehicle. For example, the body information may include ages, body sizes, and weights of passengers in the vehicle.

Furthermore, the sensing device 200 may be configured to include: a door sensor for detecting whether a door is open to detect whether a passenger is in the vehicle; a belt fastening detection sensor for detecting whether a seat belt is fastened; a load sensor for detecting a load in response to a case where a passenger is seated on a seat; a mat sensor for detecting whether a passenger is seated on a seat by detecting a current of the seat; a pressure sensor for detecting pressure in response to a case where a passenger is seated on a seat; and/or the like.

FIGS. 2A-2D illustrate views of an example seat travel section, i.e., travel range of a vehicle seat.

Referring to FIG. 2A, a moving section (slide section) of the vehicle seats may be divided into the seating section A and the non-seating sections B and C by law. By law, the vehicle seats may be moved within the seating section A. In this case, as shown in FIG. 2B, a frontmost position of the seating section A becomes the reference position 240, and by law, the vehicle seat may be allowed to move to the reference position 240. However, in the present disclosure, first-row seats of the vehicle may be moved to the non-seating section B when necessary, so as to provide additional, i.e., longer space for passengers seated on the second-row seats, thereby increasing convenience of passengers seated on the second row.

Referring to FIG. 2C, the first-row seats of the vehicle may be moved to the extended position 270, which is the frontmost position of the non-seating section B, to provide the added or longer space for passengers seated on the second-row seats.

In FIG. 2D, the seating section A may be divided into multiple sections, and the first-row seats may be controlled to selectively move to any of the positions 240, 230, and 220. For example, the first-row seat may be moved and controlled to one of the positions 240, 230, and 220 within the seating section A according to the leg length of the passenger seated on the second-row seat.

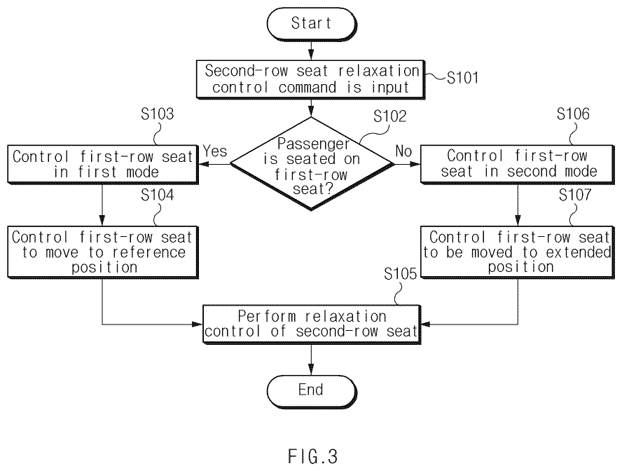

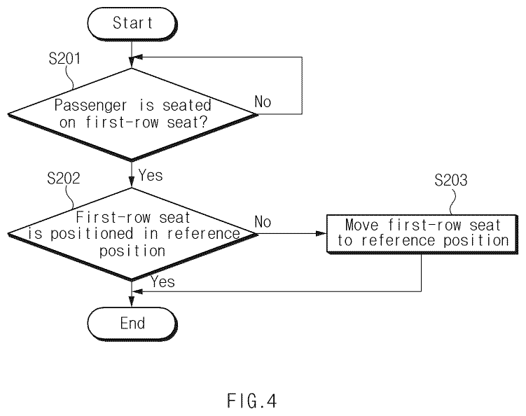

Hereinafter, a vehicle seat method according to an embodiment of the present disclosure is described with reference to FIGS. 3 and 4. FIG. 3 illustrates a flowchart of an example control method of a second-row seat in a vehicle. FIG. 4 illustrates a flowchart of an example control method of a first-row seat in a vehicle.

Hereinafter, it is assumed that the vehicle seat control apparatus 100 of FIG. 1 performs processes of FIGS. 3 and 4. In addition, in the description of FIGS. 3 and 4, operations described as being performed by the device may be understood as being controlled by the processor 140 of the vehicle seat control apparatus 100. In the following embodiments, operations S101 to S203 may be performed sequentially, but are not necessarily performed sequentially. For example, an order of each operation may be changed, and at least two operations may be performed in parallel.

Referring to FIG. 3, as a second-row seat relaxation control command is input (S101), the vehicle seat control apparatus 100 may be configured to determine whether a passenger is seated on the first-row seat (S102). In the instant case, the second row seat relaxation control command may be input by a user through switch or button manipulation. Furthermore, the vehicle seat control apparatus 100 may be configured to determine whether a passenger is in the first-row seat through a load sensor, a pressure sensor, a mat sensor, and/or the like mounted on the first-row seat. Furthermore, the vehicle seat control apparatus 100 may be configured to determine that a passenger is in the first-row seat in a case where a door at a first-row seat side is opened or a seat belt of the first-row seat is fastened. Furthermore, the vehicle seat control apparatus 100 may be configured to determine that a passenger is in the first-row seat in a case where a switch for controlling sliding of the first-row seat is operated or a switch for moving the first-row seat from the non-seating section to the seating section is operated.

In response to a case where a passenger is in the first-row seat (YES at S102), the vehicle seat control apparatus 100 may be configured to control the first-row seat in a first mode (S103) and to control the first-row seat to move to a reference position (S104).

In the instant case, the first mode may be a normal mode, which is a mode that moves the first row of seats to the reference position specified by regulations, as shown in FIG. 2B. That is to say, the reference position 240 may indicate a frontmost position of the seating section A specified by law, as shown in FIG. 2B.

After the first-row seat is moved to the reference position 240, the vehicle seat control apparatus 100 may be configured to perform relaxation control of the second-row seat (S105). In the instant case, the relaxation control of the second-row seats may indicate that the reclining of the second-row seats is controlled to the frontmost position, the tilt is controlled to the lowest position, and the height is controlled to the lowest position, so passengers sitting in the second-row seats may be seated on a most comfortable or relaxed position possible.

Meanwhile, in the operation S102, in a case where there is no passenger on the first-row seat (NO at S102), the vehicle seat control apparatus 100 may be configured to control the first-row seat in a second mode (S106) and to control the first-row seat to be moved to the extended position as shown in FIG. 2C (S107). In one example, the second mode may be a VIP maximization mode, which allows a position of the first-row seats to be moved to the extended position, which is the non-seating section, to provide a maximum space for passengers seated on the second-row seats. In the instant case, the extended position may be a position 270 in FIG. 2C, which indicates the position 270 extended from the seating section A to the non-seating section B.

After the first-row seat is moved to the extended position, the vehicle seat control apparatus 100 may be configured to perform relaxation control of the second-row seat (S105).

Referring to FIG. 4, the vehicle seat control apparatus 100 may be configured to determine whether a passenger is seated on the first-row seat (S201). The vehicle seat control apparatus 100 may be configured to determine whether a passenger is in the first-row seat through a load sensor, a pressure sensor, a mat sensor mounted, and/or the like on the first-row seat. Furthermore, the vehicle seat control apparatus 100 may be configured to determine whether a passenger is in the first-row seat based on whether the door at the first row-seat side is open, whether the seat belt is fastened, whether a switch for controlling sliding of the first-row seat is operating, and/or whether the switch for moving the first-row seat from the non-seating section to the seating section is operated.

In response to a case where a passenger is on the first-row seat (YES at S201), the vehicle seat control apparatus 100 may determine whether the first-row seat is currently in the reference position (S202). In other words, as in FIG. 2B, it may be determined whether the first-row seat is positioned at the reference position 240 which is the frontmost portion of the seating section A.

In a case where the first row seat is not positioned at the reference position 240 (NO at S202), the vehicle seat control apparatus 100 may be configured to move the first-row seat to the reference position 240 (S203). For example, the first-row seat may be positioned at the extended position 270 instead of the reference position 240, in the instant case, the first row seat may be returned to the reference position 240. Furthermore, the vehicle seat control apparatus 100 may prevent movement of the first-row seat by restricting manual manipulation by a passenger in a case where the first-row seat is positioned in the non-seating sections B and C. However, as manipulation in a direction of the seating section A is input, the vehicle seat control apparatus 100 may be configured to automatically return the first-row seat to the seating section A according to whether there are passengers in the second row.

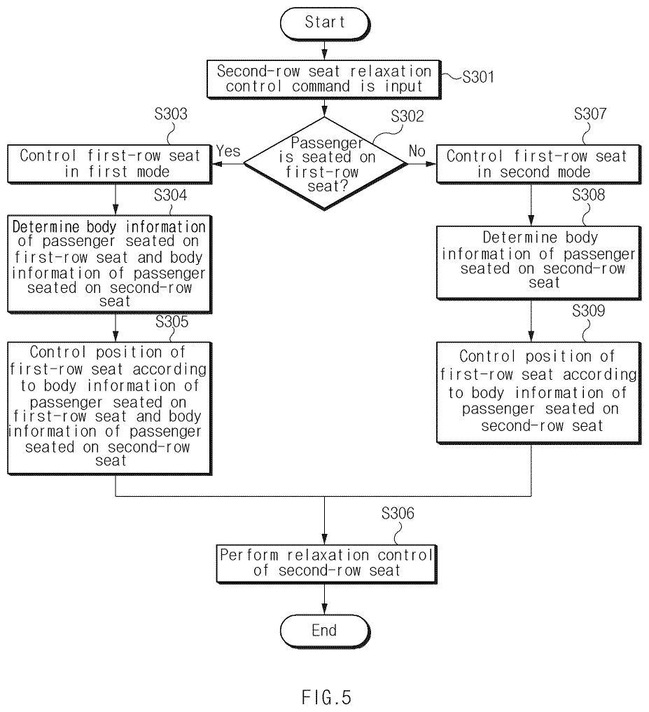

Hereinafter, a vehicle seat control method according to an embodiment of the present disclosure is described in detail with reference to FIGS. 5-7.

Hereinafter, it is assumed that the vehicle seat control apparatus 100 of FIG. 1 performs the processes of FIGS. 5-7. In addition, in the description of FIGS. 5-7, operations described as being performed by the device may be understood as being controlled by the processor 140 of the vehicle seat control apparatus 100. In the following embodiments, operations of steps S301 to S509 may be performed sequentially, but are not necessarily performed sequentially. For example, an order of each operation may be changed, and at least two operations may be performed in parallel.

In FIGS. 5-7, rather than controlling the movement of the first-row seats to a single reference position, a process of segmenting and controlling the movement of the first-row seats based on body information of the passengers seated on the first-row seats and body information of the passengers seated on the second-row seats is specifically described.

FIG. 5 illustrates a flowchart of another example of a control method of a second-row seat in a vehicle.

Referring to FIG. 5, in a case where a second-row seat relaxation control command is input (S301), the vehicle seat control apparatus 100 may be configured to determine whether a passenger is seated on the first-row seat (S302). In one example, a process of determining whether a passenger is on the first row seat may be the same as the description of S102 in FIG. 3 described above, so a detailed description thereof has been omitted.

In a case where a passenger is seated on the first-row seat (YES at S302), the vehicle seat control apparatus 100 may be configured to control the first-row seat in a first mode (S303), and may determine body information of the passenger seated on the first-row seat and body information of the passenger seated on the second-row seat (S304). In the instant case, the vehicle seat control apparatus 100 may determine the body information of the passenger seated on the first-row seat and the body information of the passenger seated on the second-row seat based on profile information of the passengers stored in the storage 120 in advance or based on an image of the passengers captured using a camera among the sensing devices 200. In this case, the passenger profile information may include age, height, seated height, etc. as information of the passengers, and may be entered in advance by the passenger to be stored. Furthermore, the passenger profile information may be wirelessly transmitted from a user terminal carried by each passenger.

Furthermore, the vehicle seat control apparatus 100 may be configured to pre-store data and an algorithm. The algorithm may be configured to analyze an image of a passenger captured using a camera to determine whether the passenger is an infant or under a predetermined age, and to determine whether the passenger is an infant or under a predetermined age each time the passenger gets on board, i.e., enters the vehicle and sits on a seat.

Next, the vehicle seat control apparatus 100 may be configured to control a position of the first-row seat based on body information of the passenger seated on the first-row seat and based on body information of the passenger seated on the second-row seat.

In other words, the vehicle seat control apparatus 100 may be configured to divide the seating section A into segments as shown in FIG. 2B based on the body information of the passenger seated on the first-row seat and based on the body information of the passenger seated on the second-row seat, and may be configured to move the first-row seat to one of the positions 240, 230, and 220.

As such, after the position of the first-row seat has been moved, the vehicle seat control apparatus 100 may be configured to perform relaxation control of the second-row seat (S306).

Meanwhile, in the operation S302, in a case where there is no passenger in the first-row seat (NO at S302), the vehicle seat control apparatus 100 may be configured to control the first-row seat in a second mode (S307) and determine the body information of the passenger seated on the second-row seat. In the instant case, the vehicle seat control apparatus 100 may determine the body information of the passenger seated on the second-row seat based on profile information of the passengers stored in the storage 120 in advance or based on an image of the passenger captured using a camera among the sensing devices 200 (S308).

The vehicle seat control apparatus 100 may be configured to control a position of the first-row seat according to the body information of the passenger seated on the second-row seat (S309).

For example, in a case where there is no passenger in the first-row seat and the passenger seated on the second-row seat is an adult with long legs, the position of the first-row seat may be controlled to move the first-row seat to the position 240 or 270 in FIG. 2B. In a case where there is no passenger in the first-row seat and the passenger seated on the second-row seat is a toddler with short legs, the position of the first-row seat may be controlled to move the first-row seat to position 220 in FIG. 2B.

In this way, after the position of the first-row seat is moved according to the body information of the passenger seated on the second-row seat, the vehicle seat control apparatus 100 may be configured to perform relaxation control of the second-row seat (S306).

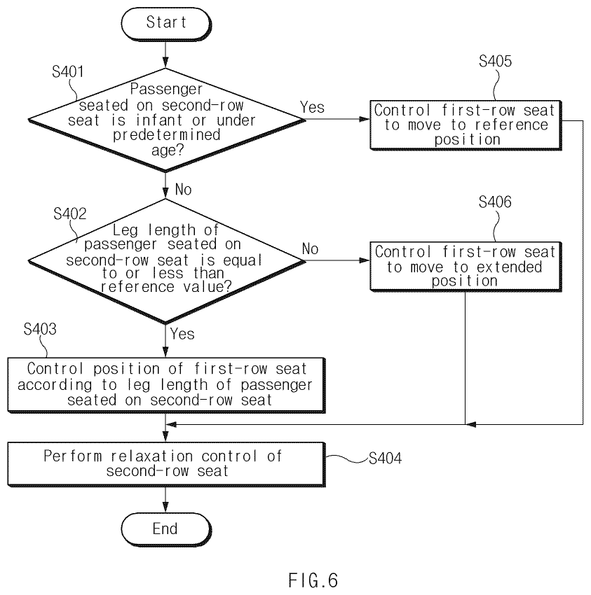

FIG. 6 illustrates a flowchart of a control method of a second-row seat according to body information of a passenger seated on the second-row seat of FIG. 5.

Referring to FIG. 6, the vehicle seat control apparatus 100 may be configured to determine whether a passenger seated on the second-row seat is an infant or under a predetermined age (S401). In one example, the vehicle seat control apparatus 100 may be configured to determine whether a passenger seated on the second-row seat is an infant or under a predetermined age based on an image captured by a camera mounted inside the vehicle. Furthermore, the vehicle seat control apparatus 100 may be configured to identify a passenger by comparing a captured image of the passenger with pre-stored image data and determine the age based on passenger profile information. Furthermore, the vehicle seat control apparatus 100 may be configured to determine the age of the passenger based on an algorithm that analyzes an image taken by photographing the passenger.

In a case where the passenger seated on the second-row seat is not an infant or is not under a predetermined age (NO at S401), i.e., in a case where the passenger seated on the second-row seat is over a predetermined age, the vehicle seat control apparatus 100 may be configured to determine whether a leg length of the passenger seated on the second-row seat is equal to or less than a reference value (S402).

In the instant case, the vehicle seat control apparatus 100 may be configured to determine the leg length by subtracting a seated height from a standing height of the passenger seated on the second-row seat and, after inputting and storing the leg length of each passenger in advance, to identify the passenger using a camera and obtain leg length information of the passenger.

The vehicle seat control apparatus 100 may be configured to control a position of the first-row seat according to the leg length of the passenger seated on the second-row seat (S403).

Table 1 below is a table that matches sliding positions of the first-row seats according to the leg length of the passengers. Such a table may be determined and stored in advance by experimentation to determine the values.

TABLE 1

| Leg length | First-row seat sliding position |
|---|---|
| 80 cm to 70 cm | 240 |
| 69 cm to 60 cm | 230 |
| 59 cm to 55 cm | 220 |
| . . . | . . . |

As shown in Table 1, for example, in a case where the leg length of a passenger seated on the second-row seat is 63 cm, the first-row seat may be moved to the position 230 within the seating section A of FIG. 2D.

In other words, the leg length of the passenger seated on the second-row is short. Thus, a space provided to the passenger seated on the second row may not need to be very long, so the first row seat may be moved to the position 230, which is a middle position rather than the frontmost position of the seating section A.

However, in a case where the leg length of a passenger seated on the second-row seat is not less than the reference value (NO at S402), i.e., in a case where the leg length of a passenger seated on the second-row seat is greater than the reference value, the vehicle seat control apparatus 100 may be configured to control the first-row seat to move to the extended position 270, which is the frontmost position in the non-seating section B (S406).

As such, after the position of the first-row seat is controlled (S403 and S406), the vehicle seat control apparatus 100 may be configured to perform relaxation control of the second-row seat (S404), thereby providing an optimized space to a passenger seated on the second-row seat.

Meanwhile, in the operation S401, in a case where the passenger seated on the second-row seat is an infant or under a predetermined age (YES at S401), the vehicle seat control apparatus 100 may control the first-row seat to move to the reference position 240 which is the frontmost portion of the seating section A (S405). Thereafter, the vehicle seat control apparatus 100 may be configured to perform relaxation control of the second-row seat (S404), thereby providing an optimized space to a passenger seated on the second-row seat.

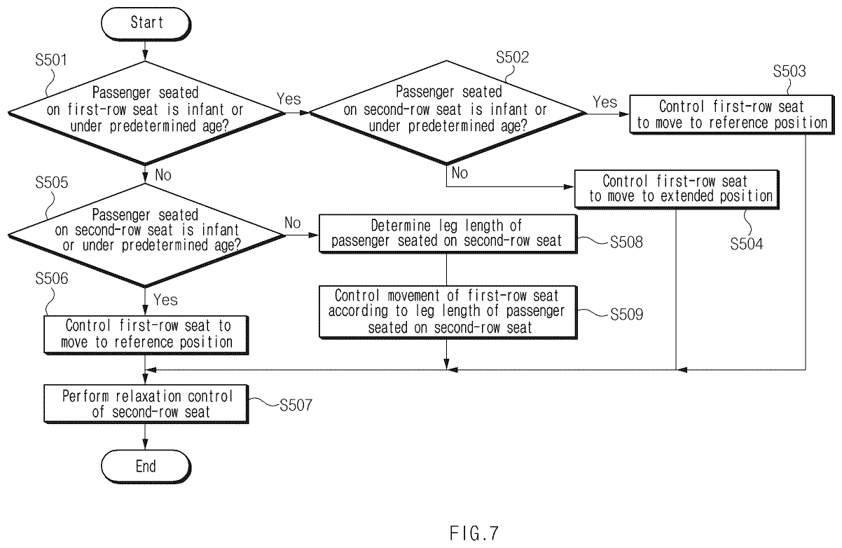

FIG. 7 illustrates a flowchart of a control method of a second-row seat based on body information of a passenger seated on a first-row seat and based on body information of a passenger seated on a second-row seat in FIG. 5.

Referring to FIG. 7, the vehicle seat control apparatus 100 may be configured to determine whether a passenger seated on the first-row seat is an infant or under a predetermined age (S501).

In a case where the passenger seated on the first-row seat is an infant or under a predetermined age (YES at S501), the vehicle seat control apparatus 100 may be configured to determine whether the passenger seated on the second-row seat is an infant or under a predetermined age (S502).

In a case where the passenger seated on the second-row seat is an infant or younger than the predetermined age (YES at S502), the vehicle seat control apparatus 100 may be configured to control the first-row seat to move to the reference position 240 (S503).

Meanwhile, in the operation S502, in a case where the passenger seated on the second-row seat is not an infant or is older than the predetermined age (NO at S502), the vehicle seat control apparatus 100 may be configured to control the first-row seat to move to the extended position 270 (S504).

Furthermore, in the operation S501, in a case where the passenger seated on the first row seat is not an infant or is older than the predetermined age (NO at S501), the vehicle seat control apparatus 100 may be configured to determine whether the passenger seated on the second-row seat is an infant or under a predetermined age (S505).

In a case where the passenger seated on the second-row seat is an infant or younger than the predetermined age (YES at S505), the vehicle seat control apparatus 100 may be configured to control the first-row seat to move to the reference position 240 (S506).

As such, after the first row seat is controlled to move to the reference position 240, the vehicle seat control apparatus 100 may be configured to perform relaxation control of the second-row seat (S507).

Meanwhile, in the operation S505, in a case where the passenger seated on the second-row seat is not an infant or is older than the predetermined age (NO at S505), the vehicle seat control apparatus 100 may be configured to determine the leg length of the passenger seated on the second-row seat (S508) and to control the movement of the first-row seat according to the leg length of the passenger seated on the second-row seat (S509). In the instant case, the vehicle seat control apparatus 100 may be configured to control the position of the first-row seat differently according to the leg length as shown in Table 1 described above.

In the instant case, according to the present disclosure, it may be possible to control not only sliding of the first-row seat, but also the reclining, tilt, height, etc. of the second-row seat to be optimized in order to provide a maximum space to a passenger seated on the second-row seat.

For example, in a case of controlling the relaxation of the second-row seat, in response to a case where there is no passenger in the first-row seat, the position of the first-row seat may be controlled to the extended position 270, and the reclining of the second-row seat may be controlled to the frontmost position, the tilt may be controlled to the lowest position, and the height may be moved to the lowest position to maximize the space provided to the passenger seated on the second-row seat.

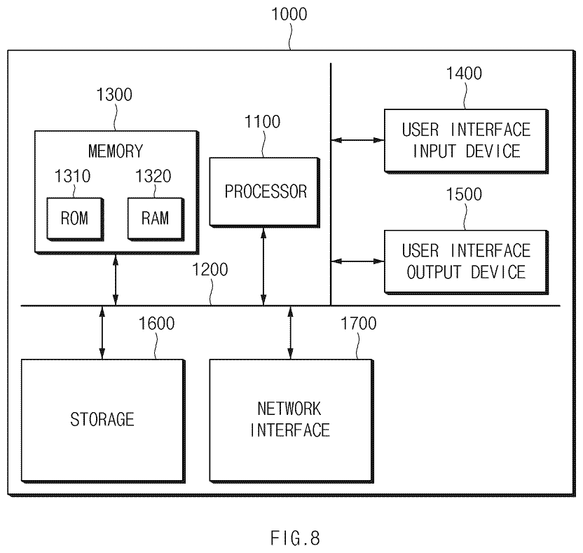

FIG. 8 illustrates an example computing system.

Referring to FIG. 8, the computing system 1000 includes at least one processor 1100 connected through a bus 1200, a memory 1300, a user interface input device 1400, a user interface output device 1500, a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an erasable programmable read-only memory (EPROM), an electrically erasable read-only memory (EEPROM), a register, a hard disk, a removable disk, and/or a CD-ROM.

An example storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal.

The above description is merely illustrative of the technical ideas of the present disclosure. Those of ordinary skill in the art to which the present disclosure pertains may make various modifications and variations without departing from the essential characteristics of the present disclosure.

Therefore, the embodiments shown and described in the present disclosure are not intended to limit the technical ideas of the present disclosure, but to explain them. The scope of the technical ideas of the present disclosure is not limited by these embodiments. The scope of protection of the present disclosure should be interpreted by the claims below, and all technical ideas within the equivalent range should be interpreted as being included in the scope of the present disclosure.

What is claimed is:

1. A seat control apparatus for a vehicle having a first-row seat and a second-row seat positioned rearward of the first-row seat, the seat control apparatus comprising:
a processor configured to control a movement position of the first-row seat according to whether a passenger is seated on the first-row seat and to then perform relaxation control of the second-row seat, in response to a relaxation control command being input for the second-row seat; and
a storage configured to store data and algorithms driven by the processor,
wherein a range of travel of the first-row seat includes a seating section pre-determined as a first portion of the range of travel permitting a passenger to sit on the first-row seat and a non-seating section pre-determined as a section portion of the range of travel not permitting a passenger to sit on the first-row seat, and
wherein the processor is configured to selectively control movement of the first-row seat to a reference position at a frontmost position of the seating section and to an extended position at a frontmost position of the non-seating section, forward of the reference position, according to whether a passenger is seated on the first-row seat.

2. The seat control apparatus of claim 1, wherein the processor is configured to control the first-row seat to move to the reference position based on determining that a passenger is seated on the first-row seat.

3. The seat control apparatus of claim 1, wherein the processor is configured to control the first-row seat to move to the extended position based on determining that no passenger is seated on the first-row seat.

4. The vehicle seat control apparatus of claim 1, wherein
the non-seating section is extended from the seating section.

5. The seat control apparatus of claim 1, wherein, based on determining that a passenger is seated on the first-row seat, the processor is configured to determine whether the first-row seat is positioned at the reference position.

6. The seat control apparatus of claim 5, wherein the processor is configured to control the first-row seat to move to the reference position based on determining that the first-row seat is positioned in the non-seating section.

7. The seat control apparatus of claim 1, wherein the processor is configured to detect whether a passenger is seated on the first-row seat based on whether a door is open, whether a seat belt is fastened, a detection result of a load sensor, a detection result of a mat sensor, an input of a seat control switch from the non-seating section to the seating section, or any combination thereof.

8. The seat control apparatus of claim 1, wherein, based on determining that no passenger is seated on the first-row seat, the processor is configured to determine body information of a passenger seated on the second-row seat and to control a position of the first-row seat based on the body information of the passenger seated on the second-row seat.

9. The seat control apparatus of claim 8, wherein the processor is configured to:
determine whether the passenger seated on the second-row seat is an infant or under a predetermined age; and
control the first row seat to move to the reference position based on determining that the passenger seated on the second row seat is an infant or under the predetermined age.

10. The seat control apparatus of claim 8, wherein, based on determining that the passenger seated on the second row seat is not an infant or is over the predetermined age, the processor is configured to determine a leg length of the passenger seated on the second-row seat.

11. The seat control apparatus of claim 10, wherein the processor is configured to:
determine whether the leg length of the passenger seated on the second-row seat is equal to or less than a reference value; and
based on determining that the leg length of the passenger seated on the second-row seat is equal to or less than the reference value, control a position of the first-row seat according to the leg length of the passenger seated on the second row seat.

12. The seat control apparatus of claim 10, wherein the processor is configured to control a position of the first-row seat to be moved to a position closer to the reference position within the seating section based on determining that the leg length of the passenger seated on the second-row seat is less than or equal to the reference value and based on the leg length of the passenger seated on the second-row seat being close to the reference value.

13. The seat control apparatus of claim 11, wherein, based on determining that the leg length of the passenger seated on the second-row seat is greater than the reference value, the processor is configured to control the first row seat to move to the extended position.

14. The seat control apparatus of claim 1, wherein, based on determining that a passenger is seated on the first-row seat, the processor is configured to:
determine body information of the passenger seated on the first-row seat and body information of a passenger seated on the second row seat; and
control a position of the first row seat based on the body information of the passenger seated on the first-row seat and the body information of the passenger seated in the second-row seat.

15. The seat control apparatus of claim 1, wherein, based on determining that no passenger is seated on the first-row seat, the processor is configured to control reclining of the second-row seat to a frontmost position along with movement control of the first-row seat, control tilt of the second-row seat to a lowest position, and control a backrest height of the second-row seat to a lowest position.

16. A seat control method for a vehicle having a first-row seat and a second-row seat positioned rearward of the first-row seat, the method comprising:
inputting a relaxation control command for the second-row seat;
controlling a position of the first-row seat based on determining whether a passenger is seated on the first-row seat; and
performing relaxation control of the second-row seat,
wherein a range of travel of the first-row seat includes a seating section pre-determined as a first portion of the range of travel permitting a passenger to sit on the first-row seat and a non-seating section pre-determined as a second portion of the range of travel not permitting a passenger to sit on the first-row seat, and
wherein controlling the position of the first-row seat includes selectively controlling movement of the first-row seat to a reference position at a frontmost position of the seating section, and to an extended position at a frontmost position of the non-seating section, forward of the seating section, according to whether a passenger is seated on the first-row seat.

17. The vehicle seat control method of claim 16, wherein controlling the moving position of the first-row seat includes controlling the first-row seat to move to the reference position based on determining that ae passenger is seated on the first-row seat.

18. The vehicle seat control method of claim 16, wherein controlling the position of the first-row seat includes controlling the first-row seat to move to the extended position based on determining that no passenger is seated on the first-row seat.

19. The vehicle seat control method of claim 16, wherein
the non-seating section is extended from the seating section.

20. The vehicle seat control method of claim 16, wherein, based on determining that a passenger is seated on the first-row seat, controlling the position of the first-row seat further includes:
determining whether the first-row sheet is positioned at the reference position; and
controlling the first-row seat to move to the reference position based on determining that the first-row seat is positioned in the non-seating section.
